(19) United States
(12) Patent Application Publication
(10) Pub. No.: US 2013/0093506 A1
(43) Pub. Date: Apr. 18, 2013

(54) SOLID STATE DISK POWER SUPPLY SYSTEM

(71) Applicants: FU-SEN YANG, Shenzhen City (CN); YUN BAI, Shenzhen City (CN); SONG-LIN TONG, Shenzhen City (CN)

(72) Inventors: FU-SEN YANG, Shenzhen City (CN); YUN BAI, Shenzhen City (CN); SONG-LIN TONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/402,885

(22) Filed: Feb. 23, 2012

(30) Foreign Application Priority Data
Oct. 13, 2011 (CN) 201110309491.4

(51) Int. Cl. G05F 3/08

(52) U.S. Cl. 327/540

(57) ABSTRACT

A solid state disk (SSD) power supply system includes power supply switching circuit. The power supply switching circuit comprises a first power input to receive a first direct current (DC) voltage signal, a second power input connected to a super capacitor to receive a second DC voltage signal provided by the super capacitor, a switching chip connected to the first and second power inputs and configured to select the second DC voltage signals to output in a situation that the first power input is disabled to receive the first DC voltage signal, a voltage converting chip to receive the voltage signal output from the switching chip, and a voltage output to output an operation voltage to an SSD according to the voltage signal. The switching chip and the voltage converting chip respectively output a first and second test signals for testing a discharging time of the super capacitor.

### BACKGROUND

1. Technical Field

The present disclosure generally relates to solid state disk (SSD) power supply systems, and particularly to a SSD power supply system capable of detecting a discharging time of a super capacitor of the SSD power supply system.

2. Description of Related Art

Super capacitors, as a power down protection element, are employed in SSD power supply systems. When a main power supply to the SSD is turned off accidentally, the super capacitor will maintain a supply of power so that the SSDs have time to store data. However, if a super capacitor has undetected inherent defects, the reliability of the SSD is effectively non-existent.

What is needed, therefore, is an SSD power supply system which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic block diagram of an SSD power supply system according to an exemplary embodiment, the SSD power supply system including a power supply switching circuit.

FIG. 2 is a schematic block diagram of the power supply switching circuit of

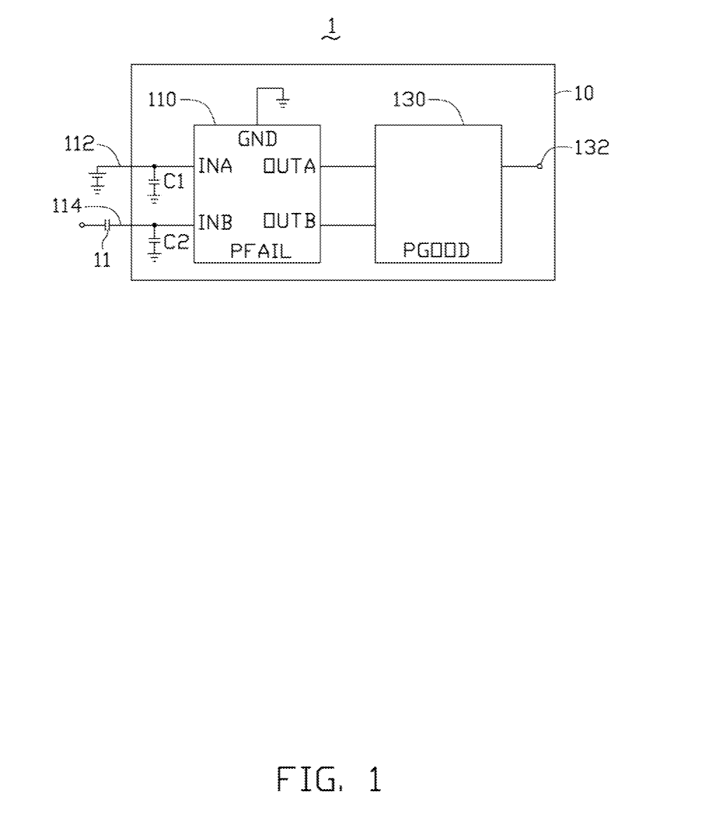

FIG. 1 connected to a detection device.

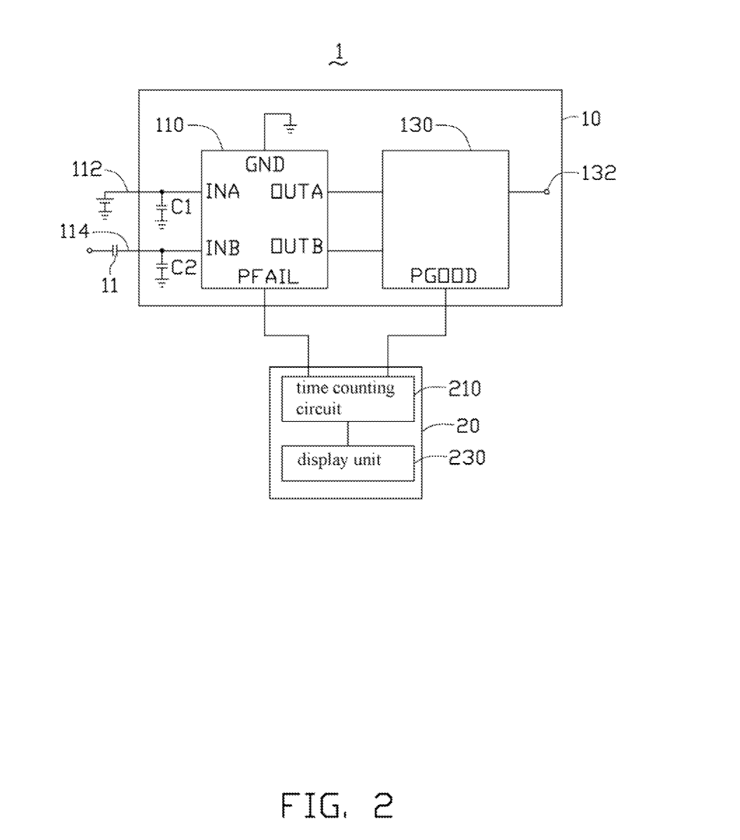

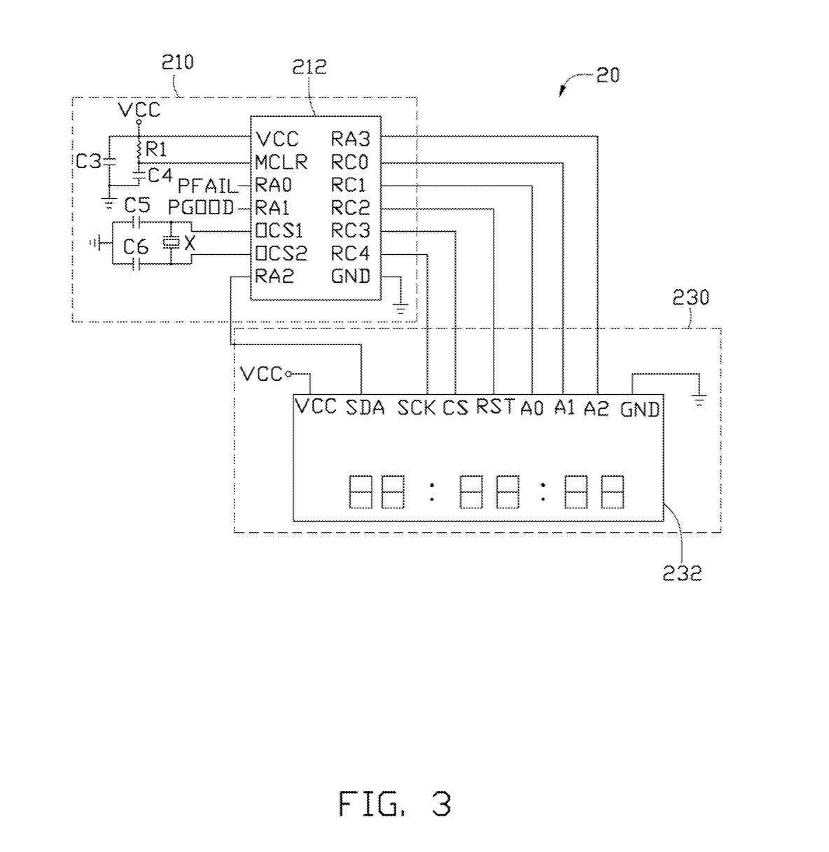

FIG. 3 is a schematic circuit diagram of the detection device of FIG. 2.

### DETAILED DESCRIPTION

Reference will be made to the drawings to describe the embodiments in detail.

FIG. 1 is a schematic block diagram of an SSD power supply system 1 according to an exemplary embodiment, the SSD power supply system 1 including a power supply switching circuit 10. In one embodiment, the SSD power supply system 1 further includes a super capacitor 11 (not shown). The super capacitor 11 may be an electric double-layer capacitor.

The switching circuit 10 includes a first power input 112, a second power input 114, a first capacitor C1, a second capacitor C2, a switching chip 110, a voltage converting chip 130, and a voltage output 132. The power input 112 is connected to a direct current (DC) power supply (not labeled), and is grounded via the capacitor C1. The power input 114 is connected to the super capacitor 11, and is grounded via the capacitor C2. The switching chip 110 includes a first voltage input pin “INA”, a second voltage input pin “INB”, a first voltage output pin “OUTA”, and a second voltage output pin “OUTB”. The voltage input pin “INA” is connected to the power input 112, the voltage input pin “INB” is connected to the power input 114, and the voltage output pins “OUTA” and “OUTB” are connected to the voltage converting chip 130. The voltage converting chip 130 provides power to an SSD (not shown, e.g., an SSD of an electronic device) via the voltage output 132.

The switching chip 110 further includes a first test pin “PFAIL”, and the voltage converting chip 130 includes a second test pin “PGOOD”. When an external power supply provides normal power to the SSD via the DC power supply, the switching chip 110 enables the voltage input pin “INA”, but disables the voltage input pin “INB”. Therefore, when the power input 112 receives a first DC voltage signal from the external power supply, the capacitor C1 filters the first DC voltage signal to a stable first DC voltage signal, and the stable first DC voltage signal is provided to the voltage input pin “INA”. The switching chip 110 outputs the first DC voltage signal to the voltage converting chip 130 via the voltage output pin “OUTA”, and the voltage converting chip 130 generates an operation voltage according to the first DC voltage signal and provides the operation voltage to power the SSD via the voltage output 132. At the same time, the external power supply charges the super capacitor 11. In addition, when the power input 112 receives the first DC voltage signal, the switching chip 110 outputs a first test signal in a high level state (e.g., a logic “1”) via the test pin “PFAIL” representing that the SSD is powered normally, and the voltage converting chip 130 outputs a second test signal in the high level state via the test pin “PGOOD” representing that the voltage converting chip 130 is in a normal operation state.

When the external power supply stops providing power to the SSD, no DC voltage is provided to the power input 112, that is, the voltage input pin “INA” is idle, and the switching chip 110 enables the voltage input pin “INB”. At the same time, the super capacitor 11 provides a second DC voltage signal to the voltage input pin “INB” via the power input 114, the switching chip 110 outputs the second DC voltage signal to the voltage converting chip 130 via the voltage output pin “OUTB”, and the voltage converting chip 130 generates the operation voltage according to the second DC voltage signal and provides the operation voltage to power the SSD via the voltage output 132. When the switching chip 110 enables the voltage input pin “INB” and disables the voltage input pin “INA”, the first test signal output from the test pin “PFAIL” changes to a low level state (e.g., a logic “0”) from the high level state, and the second test signal output from the test pin “PGOOD” of the voltage converting chip 130 maintains a high level.

When a voltage value of the second DC voltage signal output from the super capacitor 11 decreases to a preset voltage value, the second test signal output from the test pin “PGOOD” also changes to a low level state. The preset voltage value is less than the operation voltage value of the voltage converting chip 130.

FIG. 2 is schematic block diagram of the power supply switching circuit 10 connected to a detection device 20. The detection device 20 includes a time counting circuit 210 and a display unit 230 connected to the time counting circuit 210. The test pins “PFAIL” and “PGOOD” are connected to the time counting circuit 210.

When the external power supply stops providing power to the SSD, the voltage input pin “INB” is enabled, and the super capacitor 11 discharges. At the same time, the first test signal output from the test pin “PFAIL” changes to the low level state from the high level state. The first test signal which is in the low level state enables the time counting circuit 210 to start counting, and the time being counted is simultaneously displayed on the display unit 230.

When the voltage value of the second DC voltage signal output from the super capacitor 11 decreases to the preset voltage value, the second test signal output from the test pin “PGOOD” changes to the low level state from the high level state. When receiving the second test signal which is in the low level state, the time counting circuit 210 stops counting.

FIG. 3 is a schematic circuit diagram of the detection device 20. In this embodiment, the time counting circuit 210 includes a micro control unit (MCU) 212, capacitors C3, C4, C5 and C6, a resistor R1, and a crystal oscillator X. The display unit 230 includes a display 232. The display 232 may be a liquid crystal display, and has 6-bit display function to display the hour, minute, and second. The time counting circuit 210 is connected in series to the display 232.

The MCU 212 includes a first power pin “VCC”, a first ground pin “GND”, a reset pin “MCLR”, two control signal input pins “RA0” and “RA1”, two crystal oscillator pins “OCS1” and “OCS2”, and seven pins “RA2” “RA3” “RC0”, “RC1”, “RC2”, “RC3” and “RC4”. The first power pin “VCC” is connected to a power source VCC, and is grounded via the capacitor C3. The power source VCC is connected to the reset pin “MCLR” via a delay circuit consisting of the resistor R1 and the capacitor C4. The delay circuit can provide a reliable reset time to the MCU 212. The first ground pin “GND” is grounded. The control signal input pins “RAO” and “RA1” are respectively connected to the test pins “PFAIL” and “PGOOD”. The crystal oscillator X is connected between the two crystal oscillator pins “OCS1” and “OCS2”, and two terminals of the crystal oscillator X are grounded respectively via the capacitors C5 and C6.

The display 232 includes a second power pin “VCC”, a second ground pin “GND”, and seven pins “SDA”, “A2”, “Al”, “A0”, “RST”, “CS” and “SCK”. The second power pin “VCC” is connected to the power source VCC, and the second ground pin “GND” is grounded. The seven pins “SDA”, “A2”, “A1”, “A0”, “RST”, “CS” and “SCK” of the display 232 are respectively connected to the seven pins “RA2” “RA3” “RC0”, “RC1”, “RC2”, “RC3” and “RC4” of the MCU 212.

When the system 1 is powered off, the first test signal output from the test pin “PFAIL” changes to the low level state from the high level state. The first test signal which is in the low level state enables the time counting circuit 210 to start counting, and the time being counted is simultaneously displayed on the display 232.

When the voltage value of the second DC voltage signal output from the super capacitor 11 decreases to the preset voltage value, the second test signal output from the test pin “PGOOD” changes to the low level state from the high level state. When receiving the second test signal which is in the low level state, the time counting circuit 210 stops counting, and the time displayed on the display 232 is a discharging time of the super capacitor 11. That is, the discharging time of the super capacitor 11 is shown to be from a first time when the first test signal changes to the low level state from the high level state, to a second time when the second test signal changes to the low level state from the high level state.

Therefore, the power supply switching circuit 10 provides test signals to the detection device 20, and the detection device 20 detects the discharging time of the super capacitor 11 according to a level change of the test signals. Thus, the SSD power supply system 1 employing the power supply switching circuit 10 and detection device 20 can detect the discharging time of the super capacitor 11 and determine whether the super capacitor 11 used for the SSD can be relied upon.

In an alternative embodiment, the first test signal output from the switching chip 110 can be in the low level state, and when the external power supply stops providing power to the SSD, the first test signal changes to the high level state from the low level state. The first test signal which is in the high level state enables the time counting circuit 210 to start counting. The second test signal output from the voltage converting chip 130 can be in the low level state, and when the voltage value of the second DC voltage signal output from the super capacitor 11 decreases to the preset voltage value, the second test signal changes to the high level state from the low level state. The second test signal which is in the high level state makes the time counting circuit 210 stop counting.

In other embodiments, the first and second signals can trigger the counting circuit 210 to start counting or make the time counting circuit 210 stop counting by changing other parameters but are not limited to level, such as frequency.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A solid state disk (SSD) power supply system, comprising a power supply switching circuit, the power supply switching circuit comprising:
a first power input configured to receive a first direct current (DC) voltage signal;
a second power input connected to a super capacitor and configured to receive a second DC voltage signal from the super capacitor;
a switching chip connected to the first and second power inputs and configured to select the second DC voltage signal in a situation that the first power input is disabled to receive the first DC voltage signal;
a voltage converting chip configured to receive one of the first DC voltage signal and the second DC voltage signal and generate an operation voltage according to the received one of the first DC voltage signal and the second DC voltage signal; and
a voltage output configured to output the operation voltage to an SSD;
wherein the switching chip is further configured to output a first test signal in a situation that the second DC voltage signal is selected by the switching chip, and the voltage converting chip is further configured to output a second test signal in a situation that a voltage value of the second DC voltage signal decreases to a preset voltage value.

2. The SSD power supply system of claim 1, wherein the preset voltage value is less than the operation voltage value of the voltage converting chip.

3. The SSD power supply system of claim 1, wherein the switching chip is further configured to output the first test signal in a first voltage state in a situation that the first DC voltage signal is selected, and the first test signal changes to a second voltage state from the first voltage state in the situation that the second DC voltage signal is selected.

4. The SSD power supply system of claim 3, wherein the first voltage state is a high level state, and the second voltage state is a low level state.

5. The SSD power supply system of claim 3, wherein the voltage converting chip is further configured to output the second test signal in a third voltage state in the situation that one of the first DC voltage signal and the second DC voltage signal is selected, and the second test signal changes to a fourth voltage state from the third voltage state in the situation that the voltage value of the second DC voltage signal decreases to the preset voltage value.

6. The SSD power supply system of claim 5, wherein the third voltage state is a high level state, and the fourth voltage state is a low level state.

7. The SSD power supply system of claim 5, wherein a discharging time of the super capacitor is configured to be test by testing a first time when the first test signal changes to the second voltage state from the first voltage state and a second time when the second test signal changes to the fourth voltage state from the third voltage state.

8. The SSD power supply system of claim 7, wherein the discharging time of the super capacitor is from the first time to the second time.

9. A solid state disk (SSD) power supply system, comprising a power supply switching circuit, the power supply switching circuit comprising:
a first power input configured to receive a first direct current (DC) voltage signal;
a second power input connected to a super capacitor in the SSD power supply system and configured to receive a second DC voltage signal provided by the super capacitor to output;
a switching chip connected to the first and second power inputs and configured to select the second DC voltage signals to output in a situation that the first power input is disabled to receive the first DC voltage signal;
a voltage converting chip configured to receive one of the first DC voltage signal and the second DC voltage signal output from the switching chip and generate an operation voltage according to the received one of the first DC voltage signal and the second DC voltage signal; and
a voltage output configured to output the operation voltage to an SSD;
wherein the switching chip is further configured to output a first test signal in a first voltage state, in a situation that the switching chip selects the second DC voltage signal to output, the first test signal is configured to be turned in a second voltage state from the first voltage state, the voltage converting chip is further configured to output a second test signal in a third voltage state, and in a situation that a voltage value of the second DC voltage signal decreases to a preset voltage value, the second test signal is configured to be turned in a fourth voltage state.

10. The SSD power supply system of claim 9, further comprising a detection device, wherein the detection device is configured to receive the first and the second test signals, and record a first time when the first test signal is turned in the second voltage state from the first voltage state and a second time when the second test signal is turned in the fourth voltage state from the third voltage state.

11. The SSD power supply system of claim 10, wherein a discharging time of the super capacitor is defined from the first time to the second time.

12. The SSD power supply system of claim 10, wherein the first voltage state is a high level state, and the second voltage state is a low level state.

13. The SSD power supply system of claim 12, wherein the third voltage state is a high level state, and the fourth voltage state is a low level state.

14. The SSD power supply system of claim 9, wherein the preset voltage value is less than the operation voltage value of the voltage converting chip.

15. The SSD power supply system of claim 11, wherein the detection device comprises a time counting circuit, the time counting circuit is configured to count the discharging time of the super capacitor.

16. The SSD power supply system of claim 15, wherein the time counting circuit comprises a micro control unit (MCU) and a crystal oscillator connected to the MCU.

17. The SSD power supply system of claim 16, wherein the MCU comprises a reset pin, and the reset pin is connected to a power source via a delay circuit.

18. The SSD power supply system of claim 16, wherein the detection device further comprises a display unit, and the MCU is configured to control the display unit to display the discharging time.

19. The SSD power supply system of claim 9, wherein the switching chip comprises a first voltage input pin connected to the first power input, a second voltage input pin connected to the second power input, a first voltage output pin, and a second voltage output pin, and the switching chip is further configured to provide the first DC voltage signal from the first voltage input pin to the voltage converting chip via the first voltage output pin, and provide the second DC voltage signal from the second voltage input pin to the voltage converting chip via the second voltage output pin.
